(19) United States
(12) Patent Application Publication
(10) Pub. No.: US 2026/0236043 A1
(43) Pub. Date: Aug. 13, 2026

(54) MULTI-ROBOT CONTROL APPARATUS AND A ROBOT CONTROL METHOD THEREOF

(71) Applicants: HYUNDAI MOTOR COMPANY, Seoul (KR); KIA CORPORATION, Seoul (KR)

(72) Inventors: Youjin Jang, Hwaseong-si (KR); Dae Han Sim, Hwaseong-si (KR); Sukeui Hong, Hwaseong-si (KR); Seungwoo Hong, Hwaseong-si (KR)

(73) Assignees: HYUNDAI MOTOR COMPANY, Seoul (KR); KIA CORPORATION, Seoul (KR)

(21) Appl. No.: 19/277,272

(22) Filed: Jul. 22, 2025

(30) Foreign Application Priority Data
Feb. 13, 2025 (KR) 10-2025-0018535

(51) Int. Cl. G05D 1/698; G05D 1/644; G05D 1/693; G05D 101/00

(52) U.S. Cl. CPC G05D 1/6987; G05D 1/644; G05D 1/693; G05D 2101/22

(57) ABSTRACT

A multi-robot control apparatus allocates task points among a plurality of task points to each of a plurality of robots; determines a task point movement path for each of the plurality of robots to visit all of the allocated task points, for each of the plurality of robots; calculates a plurality of candidate movement direction combinations based on the task point movement path of each of the plurality of robots; calculates a sum of overlapping volumes between the plurality of robots and a sum of distances between the plurality of robots based on the task point movement path of each of the plurality of robots, for each of the plurality of candidate movement direction combinations; and determines a movement direction on the task point movement path of each of the plurality of robots by using the sum of the overlapping volumes and the sum of the distances.

### CROSS-REFERENCE TO RELATED APPLICATION

This application claims priority to and the benefit of Korean Patent Application No. 10-2025-0018535, filed with the Korean Intellectual Property Office, on Feb. 13, 2025, the entire contents of which are incorporated herein by reference.

### TECHNICAL FIELD

The present disclosure relates to a multi-robot control apparatus and a robot control method thereof.

### BACKGROUND

When a task is performed using multiple robots, it is faster and more efficient than performing the task by using just one robot.

However, when multiple robots work at the same work site at the same time, collisions may occur depending on the working movement direction of the robots. In this case, the robot enters an interlock state to stop operation to prevent collision, but the robot interlock causes the waiting time and total working time to become longer. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure provides a multi-robot control apparatus and a robot control method thereof capable of minimizing interlocks of robots.

According to one embodiment, a method for controlling a plurality of robots by executing commands stored in memory in a processor includes allocating task points among a plurality of task points to each of the plurality of robots. The method further includes determining a task point movement path for each of the plurality of robots to visit all of the allocated task points, for each of the plurality of robots. The method further includes calculating a plurality of candidate movement direction combinations based on the task point movement path of each of the plurality of robots. The method further includes calculating a sum of overlapping volumes between the plurality of robots and a sum of distances between robots based on the task point movement path of each of the plurality of robots, for each of the plurality of candidate movement direction combinations. The method further includes determining a movement direction on the task point movement path of each of the plurality of robots by using the sum of the overlapping volumes between the plurality of robots and the sum of the distances between the plurality of robots calculated for each of the plurality of candidate movement direction combinations. The method further includes controlling the plurality of robots to move according to the movement direction determined for each of the plurality of robots.

Determining the movement direction may include calculating a value of a movement direction selection cost function for each of the plurality of candidate movement direction combinations by using the sum of the overlapping volumes between the plurality of robots and the sum of the distances between the plurality of robots for each of the plurality of candidate movement direction combinations. Determining the movement direction may further include selecting a candidate movement direction combination by using the values of the movement direction selection cost function of the plurality of candidate movement direction combinations. Determining the movement direction may further include determining a movement direction on task point movement path of each of the plurality of robots according to the selected candidate movement direction combination. The movement direction selection cost function may include a first cost function for the sum of the overlapping volumes and a second cost function for the sum of the distances between the plurality of robots.

Selecting may include selecting a candidate movement direction combination having a largest value among the values of the movement direction selection cost function of the plurality of candidate movement direction combinations. Selecting may further include outputting, by the first cost function, a larger value when the sum of the overlapping volumes is decreased. Selecting may further include outputting, by the second cost function, a larger value when the sum of the distances between the plurality of robots is increased.

Selecting the candidate movement direction combination having the largest value may include, when there are two or more candidate movement direction combinations having the largest values, selecting a candidate movement direction combination having a larger value of the first cost function among two or more candidate movement direction combinations having the largest values.

Calculating the sum of the overlapping volumes between the plurality of robots and the sum of distances between the plurality of robots may include calculating volumes of the task point movement paths between the plurality of task points in the task point movement path of each of the plurality of robots, for each of the plurality of candidate movement direction combinations. Calculating the sum of the overlapping volumes between the plurality of robots and the sum of distances between the plurality of robots may further include calculating overlapping volumes between the task point movement paths of the plurality of robots for the same movement time between the plurality of task points by using the volumes of the task point movement paths between the plurality of task points calculated for each of the plurality of robots. Calculating the sum of the overlapping volumes between the plurality of robots and the sum of distances between the plurality of robots may further include calculating a total sum of the overlapping volumes between the plurality of robots by adding up the overlapping volumes calculated in the task point movement path of each of the plurality of robots, for each of the plurality of candidate movement direction combinations.

Calculating the volumes of the movement paths may include generating a cylinder having a radius reflecting a volume of the plurality of robot and a line segment representing the task point movement path as an axis in each of the movement paths between the plurality of task points of each of the plurality of robots; and calculating a volume of the cylinder as the volume of the task point movement path.

Calculating the sum of overlapping volumes between the plurality of robots and the sum of distances between robots further may include calculating the distances between the plurality of robots at the same movement time between the plurality of task points by using the volumes of the task point movement paths between the plurality of task points calculated for each of the plurality of robots, for each of the plurality of candidate movement direction combinations. Calculating the sum of overlapping volumes between the plurality of robots and the sum of distances between robots further may include calculating the sum of the distances between the plurality of robots by adding up the distances between the plurality of robots calculated from the task point movement paths of each of the plurality of robots, for each of the plurality of candidate movement direction combinations.

Calculating the distances between the plurality of robot may include calculating a distance between surfaces of cylinders representing the volumes of the task point movement paths of the plurality of robots as the distance between the plurality of robots, at the same movement time between the plurality of task points.

Calculating the distance between the surfaces of the cylinders as the distance between the plurality of robots may include calculating a minimum distance between a first line segment forming an axis of a first cylinder and a second line segment forming an axis of a second cylinder at the same movement time between the plurality of task points. Calculating the distance between the surfaces of the cylinders as the distance between the plurality of robots may further include calculating a minimum distance between a surface of the first cylinder and a surface of the second cylinder as the distance between the plurality of robots, by considering the minimum distance between the first line segment and the second line segment and a radius of the first cylinder and a radius of the second cylinder.

According to another embodiment, a multi-robot control apparatus for controlling a plurality of robots includes a memory configured to store one or more commands; and a processor, by executing the one or more commands, configured to allocate task points among a plurality of task points to each of the plurality of robots. The processor is further configured to determine a task point movement path for each of the plurality of robots to visit all of the allocated task points, for each of the plurality of robots. The processor is further configured to calculate a plurality of candidate movement direction combinations based on the task point movement path of each of the plurality of robots. The processor is further configured to calculate a sum of overlapping volumes between the plurality of robots and a sum of distances between the plurality of robots based on the task point movement path of each of the plurality of robots, for each of the plurality of candidate movement direction combinations. The processor is further configured to determine a movement direction on the task point movement path of each of the plurality of robots by using the sum of the overlapping volumes between the plurality of robots and the sum of the distances between the plurality of robots calculated for each of the plurality of candidate movement direction combinations. The processor is further configured to control the plurality of robots to move according to the movement direction on the task point movement path of each of the plurality of robots.

The processor may calculate the sum of the overlapping volumes between the plurality of robots based on the task point movement paths of each of the plurality of robots, for each of the plurality of candidate movement direction combinations. The processor may further calculate the sum of the distances between the plurality of robots based on the task point movement paths of each of the plurality of robots, for each of the plurality of candidate movement direction combinations. The processor may further select a candidate movement direction combination from among the plurality of candidate movement direction combinations by using the sum of the overlapping volumes and the sum of the distances between the plurality of robots of each of the plurality of candidate movement direction combinations. The processor may further control the plurality of robots according to the movement directions of the plurality of robots to move according to the selected candidate movement direction combination.

The processor may calculate a value of a movement direction selection cost function, including a first cost function for the sum of the overlapping volumes and a second cost function for the sum of the distances between the plurality of robots, for each of the plurality of candidate movement direction combinations by using the sum of the overlapping volumes between the plurality of robots and the sum of the distances between the plurality of robots for each of the plurality of candidate movement direction combinations. The processor may select a candidate movement direction combination having a largest value among the values of the movement direction selection cost function of the plurality of candidate movement direction combinations. The first cost function may output a larger value when the sum of the overlapping volumes is decreased, and the second cost function may output a larger value when the sum of the distances between the plurality of robots is increased.

When there are two or more candidate movement direction combinations having the largest values among the values of the movement direction selection cost function of the plurality of candidate movement direction combinations, the processor may select a candidate movement direction combination having a larger value of the first cost function among the two or more candidate movement direction combinations having the largest values.

The processor may calculate volumes of the task point movement paths between the plurality of task points in the task point movement path of each of the plurality of robots, for each of the plurality of candidate movement direction combinations. The processor may further calculate overlapping volumes between the task point movement paths of the plurality of robots for the same movement time between the plurality of task points by using the volumes of the task point movement paths between the plurality of task points calculated for each of the plurality of robots. The processor may further calculate a total sum of the overlapping volumes between the plurality of robots by adding up the overlapping volumes calculated in the task point movement path of each of the plurality of robots, for each of the plurality of candidate movement direction combinations.

The processor may generate a cylinder having a radius reflecting a volume of the robot and a line segment representing the task point movement path as an axis in each of the movement paths between the plurality of task points of each of the plurality of robots; and may calculate a volume of the cylinder as the volume of the task point movement path.

The processor may calculate the distances between the plurality of robots at the same movement time between the plurality of task points by using the volumes of the task point movement paths between the task points calculated for each of the plurality of robots, for each of the plurality of candidate movement direction combinations. The processor may further calculate the sum of the distances between the plurality of robots by adding up the distances between the plurality of robots calculated from the task point movement paths of each of the plurality of robots, for each of the plurality of candidate movement direction combinations.

The processor may calculate a distance between surfaces of cylinders representing the volumes of the task point movement paths of the plurality of robots as the distance between the plurality of robots, at the same movement time between the plurality of task points.

The processor may calculate a minimum distance between a first line segment forming an axis of a first cylinder and a second line segment forming an axis of a second cylinder at the same movement time between the plurality of task points. The processor may further calculate a minimum distance between a surface of the first cylinder and a surface of the second cylinder as the distance between the plurality of robots, by considering the minimum distance between the first line segment and the second line segment and a radius of the first cylinder and a radius of the second cylinder.

### BRIEF DESCRIPTION OF THE DRAWINGS

FIG. 1 is a schematic diagram illustrating a multi-robot system according to one embodiment of the present disclosure.

FIG. 2 is a drawing showing the multi-robot control apparatus illustrated in FIG. 1.

FIG. 3 is a drawing explaining collision between robots according to the task point movement direction of each robot.

FIG. 4 is a flowchart illustrating a method for determining the movement direction of each robot in a movement direction determiner according to one embodiment of the present disclosure.

FIG. 5 is a drawing showing an example of a method for calculating the volume of a task point movement path of a robot according to one embodiment of the present disclosure.

FIGS. 6 and 7 are drawings illustrating a method for calculating the overlapping volume between robots in any one candidate movement direction combination, respectively.

FIG. 8 is a drawing explaining the distance between robots according to one embodiment of the present disclosure.

FIG. 9 is a drawing illustrating a method for calculating the surface-to-surface distance of cylinders used as a distance between robots according to one embodiment of the present disclosure.

FIG. 10 is a drawing showing a movement direction determiner according to one embodiment of the present disclosure.

FIG. 11 is a drawing showing a collision area between robots when the movement direction in the task point movement path of each robot is not considered.

FIG. 12 is a drawing explaining collision avoidance between robots when the movement direction of each robot in the task point movement path is determined by a method for determining the movement direction of the robot according to one embodiment of the present disclosure.

FIG. 13 is a drawing showing a multi-robot control apparatus according to another embodiment of the present disclosure.

### DETAILED DESCRIPTION

Hereinafter, embodiments of the present disclosure are described in detail with reference to the appended drawings so that a person of ordinary skill in the art may easily implement the present disclosure. As those having ordinary skill in the art should realize, the described embodiments may be modified in different ways, without departing from the spirit or scope of the present disclosure. The drawings and description should be regarded as illustrative in nature and not restrictive. Like reference numerals designate like elements throughout the present disclosure.

In the flowchart described with reference to the drawings in the present disclosure, the order of operations may be changed and some operations may be merged, divided, or omitted.

Throughout the present disclosure, when a part is referred to “include” a certain element, it means that the part may further include other elements rather than exclude other elements, unless specifically indicated otherwise.

Also, expressions written in the singular may be interpreted as singular or plural, unless specifically indicated otherwise.

In addition, terms including an ordinal number, such as first, second, etc., may be used to describe various elements, but the elements are not limited by the terms. The above terms are used only for distinguishing one element from another element. For example, without departing from the scope of the present disclosure, a first element may be referred to as a second element, and similarly, a second element may be referred to as a first element.

Throughout the present disclosure, when an element is referred to as being “connected” to another element, it should be understood that the element may be directly connected to another element, or other intervening elements may be present between the element and another element. On the other hand, when an element is referred to as “directly connected” to another element, it should be understood that no other element is present between the two elements. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

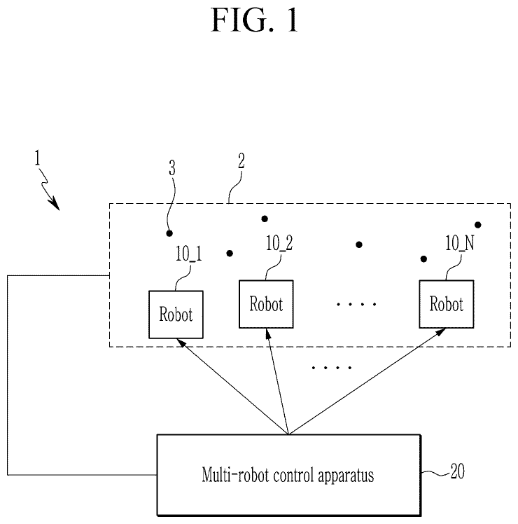

FIG. 1 is a schematic diagram illustrating a multi-robot system according to one embodiment of the present disclosure.

Referring to FIG. 1, a multi-robot system 1 is a system in which a plurality of robots 10_1 to 10_N cooperate to perform a specific task in the same task space 2. For example, a multi-robot system 1 may simultaneously weld (work) by dividing a plurality of welding points (task points) in the task space 2.

The task space 2 may include a plurality of task points 3, which are locations where a plurality of robots 10_1 to 10_N performs a task.

The multi-robot system 1 may include a plurality of robots 10_1 to 10_N and a multi-robot control apparatus 20.

The multi-robot control apparatus 20 may allocate the plurality of task points 3 in the task space 2 to the plurality of robots 10_1 to 10_N and may determine a task point movement path of each of the plurality of robots 10_1 to 10_N so that each of the plurality of robots 10_1 to 10_N may visit all of the allocated task points and may efficiently perform task.

When the plurality of robots 10_1 to 10_N perform tasks simultaneously, there is a possibility of collision in the plurality of robots 10_1 to 10_N. Thus, the multi-robot control apparatus 20 determines the movement direction for the task point movement path of each of the plurality of robots 10_1 to 10_N so as to minimize collisions between the robots on the task point movement path of each of the plurality of robots 10_1 to 10_N. When there are a first task point and a second task point, which are both endpoints of the task point movement path, the movement direction in the task point movement path may include a first direction (e.g., a forward direction) from the first task point to the second task point and a second direction (e.g., a reverse direction) from the second task point to the first task point. The multi-robot control apparatus 20 may determine the movement direction of each of the plurality of robots 10_1 to 10_N in the task point movement path as the first direction or the second direction to minimize collisions between the robots.

The multi-robot control apparatus 20 may control the plurality of robots 10_1 to 10_N to move according to the task point movement path and movement direction of each of the plurality of robots 10_1 to 10_N.

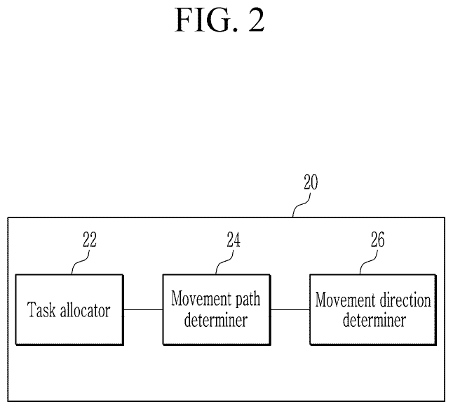

FIG. 2 is a drawing showing the multi-robot control apparatus illustrated in FIG. 1.

Referring to FIG. 2, the multi-robot control apparatus 20 may include a task allocator 22, a movement path determiner 24, and a movement direction determiner 26.

The task allocator 22 may allocate a plurality of task points 3 in the task space 2 to the plurality of robots 10_1 to 10_N. The task allocator 22 may allocate task points (3) to each of the plurality of robots 10_1 to 10_N by considering the positions of the robots 10_1 to 10_N, the positions of the task points 3, the expected time taken to perform the task at the corresponding task point, and the expected time to move between the task points, etc. For example, the task allocator 22 may allocate task points 3 to each of the plurality of robots 10_1 to 10_N in a way that minimizes the difference in task completion times of the plurality of robots 10_1 to 10_N by considering the positions of the robots 10_1 to 10_N, the positions of the task points 3, the expected time taken to perform the work at the corresponding task point 3, and the expected time to move between the task points 3, etc.

When the allocation of task points 3 to each of the plurality of robots 10_1 to 10_N is completed by the work allocator 22, the movement path determiner 24 may determine the task point movement path of each of the plurality of robots 10_1 to 10_N so that each of the plurality of robots 10_1 to 10_N may visit all of the allocated task points and perform the tasks.

In some embodiments, the movement path determiner 24 may determine the task point movement path for each of the plurality of robots 10_1 to 10_N in a way that minimizes the movement path that visits all of the allocated task points. For example, when five task points are allocated to a robot A, the task point movement path of the robot A may be determined in a way that minimizes the movement distance for the robot A to visit all five task points.

The each of the plurality of robots 10_1 to 10_N may perform tasks at the allocated task points while moving along a determined task point movement path. At this time, collisions between robots may occur.

The movement direction determiner 26 may predict collisions between robots based on the task point movement path of each of the plurality of robots 10_1 to 10_N and may determine the movement direction in the task point movement path of each of the plurality of robots 10_1 to 10_N to minimize collisions between the robots.

The movement direction determiner 26 may calculate a plurality of candidate movement direction combinations based on the task point movement path of each of the plurality of robots 10_1 to 10_N. The movement direction determiner 26 may calculate a sum of overlapping volumes between robots and a sum of distances between robots based on the task point movement path of each of the plurality of robots 10_1 to 10_N, for each of the plurality of candidate movement direction combinations. The movement direction determiner 26 may determine the movement direction in the task point movement path of each of the plurality of robots 10_1 to 10_N using the calculated results.

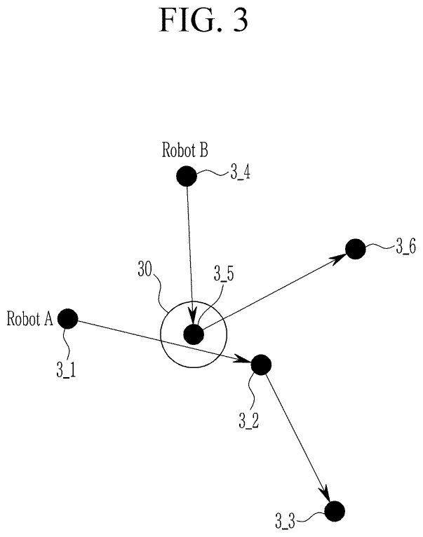

FIG. 3 is a drawing explaining collision between robots according to the task point movement direction of each robot.

Referring to FIG. 3, three task points 3_1, 3_2, and 3_3 may be allocated to the robot A, and three task points 3_4, 3_5, and 3_6 may be allocated to the robot B, by the task allocator 22.

In addition, the task point movement path of the robot A may be determined with task point 3_1 and task point 3_3 as both end points by the movement path determiner 24, and the task point movement path of the robot B may be determined with task point 3_4 and task point 3_6 as both end points by the movement path determiner 24.

At this time, if the movement direction in the task point movement path of the robot A is set to the task point 3_1 as the start point of the task and the task point 3_3 as the end point of the task, and if the movement direction in the task point movement path of the robot B is set to the task point 3_4 as the start point of the task and the task point 3_6 as the end point of the task, there is a high possibility that a collision will occur between robot A and robot B at position 30. In other words, there is a high possibility of a collision occurring when the robot A moves from task point 3_1 to task point 3_2 and the robot B moves from task point 3_4 to task point 3_5. Here, it is assumed that the actual tasking time spent by the robots A and B at each task point is the same.

The movement direction determiner 26 according to an embodiment may determine a candidate movement direction combination that minimizes collision between the robot A and the robot B among a plurality of candidate movement direction combinations for directions that may be moved in the task point movement path of the robot A and directions that may be moved in the task point movement path of the robot B. The movement direction determiner 26 may determine the movement direction in the task point movement path of the robot A and the movement direction in the task point movement path of the robot B according to the determined candidate movement direction combination. For example, if the movement direction in the task point movement path of the robot A is determined with the task point 3_1 as the start point of the task and the task point 3_3 as the end point of the work, and the movement direction in the task point movement path of the robot B is determined with the task point 3_6 as the start point of the task and the task point 3_4 as the end point of the task, the collision between the robot A and the robot B may be avoided.

Below, it is assumed that task points are allocated to each of the plurality of robots by the task allocator 22 and the task point movement path is determined for each of the plurality of robots by the movement path determiner 24, and a method for determining the movement direction of each of the plurality of robots is described.

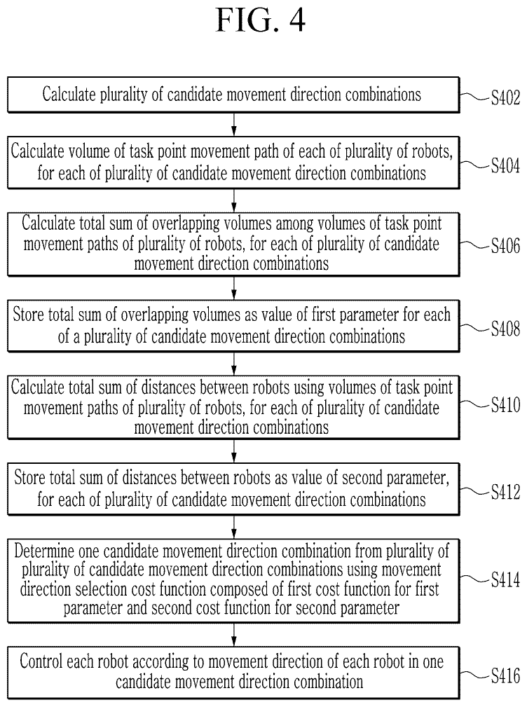

FIG. 4 is a flowchart illustrating a method for determining the movement direction of each robot in a movement direction determiner according to one embodiment of the present disclosure.

Referring to FIG. 4, the movement direction determiner 26 may calculate a plurality of candidate movement direction combinations by using the number of cases for the movement direction in which each of the plurality of robots may move on the task point movement path of each of the plurality of robots (S402). For example, three robots may perform a task in a task space 2, and there may be two movement directions, i.e., a first direction and a second direction in which each of the three robots may move on the task point movement path of each of three robots. In this case, eight candidate movement direction combinations may be calculated from the number of cases for movement directions in which each of the three robots may move along the task point movement path, as shown in Table 1.

In Table 1, “1” represents the first direction and “−1” represents the second direction.

TABLE 1

| | Case1 | Case2 | Case3 | Case4 | Case5 | Case6 | Case7 | Case8 |
|---|---|---|---|---|---|---|---|---|
| Robot 1 | 1 | 1 | 1 | 1 | −1 | −1 | −1 | −1 |
| Robot 2 | 1 | 1 | −1 | −1 | −1 | −1 | 1 | 1 |
| Robot 3 | 1 | −1 | 1 | −1 | −1 | 1 | −1 | 1 |

The movement direction determiner 26 may calculate the volume of the task point movement path of each of the plurality of robots in each of the plurality of candidate movement direction combinations (S404). The movement direction determiner 26 may calculate the task point movement path of each of the plurality of robots in a specific volume.

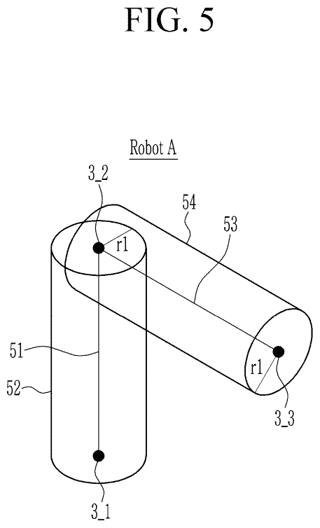

FIG. 5 is a drawing showing an example of a method for calculating the volume of a task point movement path of a robot according to one embodiment of the present disclosure.

Referring to FIG. 5, when the task point movement path of the robot A has task point 3_1 and task point 3_3 as both endpoints and task point 3_2 as the midpoint, the movement direction determiner 26 may express the movement distance between task point 3_1 and task point 3_2 as a line segment 51 and may generate a cylinder 52 having a predetermined radius r1 centered on the corresponding line segment 51 in order to reflect the size (volume) of the robot and/or the safety distance between robots. In addition, the movement direction determiner 26 may express the movement distance between the task point 3_2 and the task point 3_3 as a line segment 53 and may generate a cylinder 54 having the radius r1 centered on the corresponding line segment 53 to reflect the size (volume) of the robot and/or the safety distance between the robots.

The movement direction determiner 26 may calculate the volume of the cylinder 52 and the volume of the cylinder 54 as the movement volume formed when the robot A moves along the task point movement path. Hereinafter, the movement volume formed when a robot moves along the corresponding task point movement path is called the volume of the task point movement path.

In this way, the movement direction determiner 26 may calculate the volume of the task point movement path through cylinder modeling that reflects the actual size (volume) of the robot.

The cylinder modeling is one example that may be used to calculate the volume of the task point movement path when the robot is cylindrical or the movement path is linear, and other modeling methods may be used depending on the shape of the robot and movement path pattern.

Again, referring to FIG. 4, the movement direction determiner 26 may calculate an overlapping volume, which is an overlapping volume between the robots among the volumes of the task point movement paths of the plurality of robots, for each of the plurality of candidate movement direction combinations and may calculate the total sum of the overlapping volumes for each of the plurality of candidate movement direction combinations (S406). At this time, the total sum of the overlapping volumes may be defined as the first parameter.

The movement direction determiner 26 may store the total sum of overlapping volumes as the value of the first parameter, for each of a plurality of candidate movement direction combinations (S408).

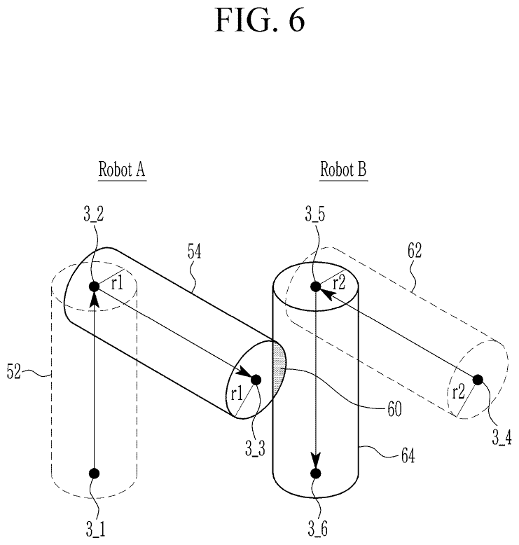

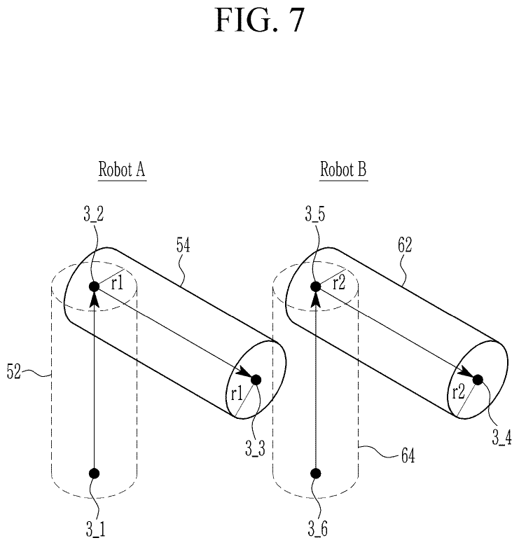

FIGS. 6 and 7 are drawings illustrating a method for calculating the overlapping volume between robots in any one candidate movement direction combination, respectively.

Referring to FIG. 6, in any one candidate movement direction combination, the movement direction of the task point movement path of the robot A has the task point 3_1 as the start point and the task point 3_3 as the end point, and the movement direction of the task point movement path of the robot B has the task point 3_4 as the start point and the task point 3_6 as the end point.

In the candidate movement direction combinations illustrated in FIG. 6, the movement direction determiner 26 may calculate the volumes of the movement paths of the robot A and the robot B for the same time, respectively.

First, the movement direction determiner 26 may generate cylinders 52 and 62 representing the volumes of the path from the start point to the midpoint, which is the next task point, for the robot A and the robot B in a first step, i.e., the time it takes for the robot A and the robot B to move from the start point to the midpoint, and may check whether there is an overlapping portion between the cylinders 52 and 62 calculated for each of the robots A and B.

Next, the movement direction determiner 26 may generates cylinders 54 and 64 representing the volume of the path from the midpoint to the end point, which is the next task point for the robot A and the robot B in a second step, i.e., the time it takes for robot A and robot B to move from the midpoint to the end point, and may check whether there is an overlapping portion between the cylinders 54 and 64 calculated for each of robots A and B.

In this way, the movement direction determiner 26 may calculate the volume of the movement path between the task points at each step for the task point movement paths of each of the robots A and robot B, and may check whether there is an overlapping portion between the volumes of the movement paths calculated for each of the robots at each step.

The movement direction determiner 26 may calculate the total sum of the overlapping volume calculated in the first step and the overlapping volume calculated in the second step for the candidate movement direction combinations shown in FIG. 6. In the case of FIG. 6, there is no overlapping portion between the cylinders 52 and 62 calculated for the robot A and the robot B in the first step, so the overlapping volume is 0 in the first step, but there is an overlapping portion 60 between the cylinders 54 and 64 calculated for robot A and robot B in the second step, and the overlapping volume of the overlapping portion 60 may be calculated in the second step.

The movement direction determiner 26 may store the total sum of the overlapping volume calculated in the first step and the overlapping volume calculated in the second step as the value of the first parameter in the candidate movement direction combination.

Meanwhile, referring to FIG. 7, in any one candidate movement direction combination, the movement direction of the task point movement path of robot A has the task point 3_1 as the start point and the task point 3_3 as the end point, and, unlike FIG. 6, the movement direction of the task point movement path of the robot B has the task point 3_6 as the start point and the task point 3_4 as the end point.

In the candidate movement direction combinations illustrated in FIG. 7, the movement direction determiner 26 may calculate the volumes of the movement paths of the robot A and the robot B for the same time, respectively.

First, the movement direction determiner 26 may generate cylinders 52 and 64 representing the volumes of the path from the start point to the midpoint for the robot A and the robot B in the first step and may check whether there is an overlapping portion between the cylinders 52 and 64 calculated for the robot A and the robot B.

Next, the movement direction determiner 26 may generate cylinders 54 and 62 representing the volumes of the path moving from the midpoint to the end point for the robot A and the robot B in the second step and may check whether there is an overlapping portion between the cylinders 54 and 62 calculated for robot A and robot B.

The movement direction determiner 26 may calculate the total sum of the overlapping volume calculated in the first step and the overlapping volume calculated in the second step for the candidate movement direction combinations shown in FIG. 7. In the case of FIG. 7, there is no overlapping portion between the cylinders 52 and 64 for the robot A and the robot B in the first step and between the cylinders 52 and 64 for the robot A and the robot B in the second step, so the total sum of the overlapping volumes for the candidate movement direction combinations shown in FIG. 7 may be 0.

The movement direction determiner 26 may store the total sum of the overlapping volume calculated in the first step and the overlapping volume calculated in the second step as the value of the first parameter in the candidate movement direction combination.

Meanwhile, comparing FIGS. 6 and 7, it may be seen that the total sum of the overlapping volumes changes depending on the movement direction of the task point movement paths of robots A and B.

In other words, depending on the movement direction of the task point movement paths of robot A and robot B, there may or may not be an overlapping portion between the movement paths of the robot A and the robot B. Accordingly, the movement direction determiner 26 may calculate the total sum of the overlapping volume between the robots in the volume of the task point movement paths of the plurality of robots, for all candidate movement direction combinations. The movement direction determiner 26 may store the total sum of the overlapping volume as the value of the first parameter, for each of plurality of candidate movement direction combinations. The movement direction determiner 26 may use the values of the first parameter for each of plurality of candidate movement direction combinations when determining the movement direction.

In FIGS. 6 and 7, because only two robots are illustrated, the sum of the overlapping volumes between the robots A and B calculated in the first step and the second step is calculated as the value of the first parameter in the candidate movement direction combination. However, if robots A, B, and C exist, the overlapping volumes between the robots A and B, the robots A and C, and the robots B and C may be calculated in the first step, and the overlapping volumes between the robots A and B, the robots A and C, and the robots B and C may also be calculated in the second step, and the sums of these may be stored as the value of the first parameter in the candidate movement direction combination.

In this way, the movement direction determiner 26 may calculate the volumes of the task point movement paths of the plurality of robots in the task space 2 for each of the plurality of candidate movement direction combinations and may calculate the sum of the overlapping volumes between the plurality of robots for each of the plurality of candidate movement direction combinations.

Again, referring to FIG. 4, the movement direction determiner 26 may calculate the distance between robots by using the volumes of the task point movement paths of the plurality of robots at the same time (step) for each of the multiple candidate movement direction combinations and may calculate the total sum of the distances between robots calculated at each time (step) (S410). At this time, the sum of the distances between robots calculated from one candidate movement direction combination may be defined as a second parameter.

The movement direction determiner 26 may store the total sum of the distances between robots calculated at each time (step) as the value of the second parameter, for each of a plurality of candidate movement direction combinations (S412).

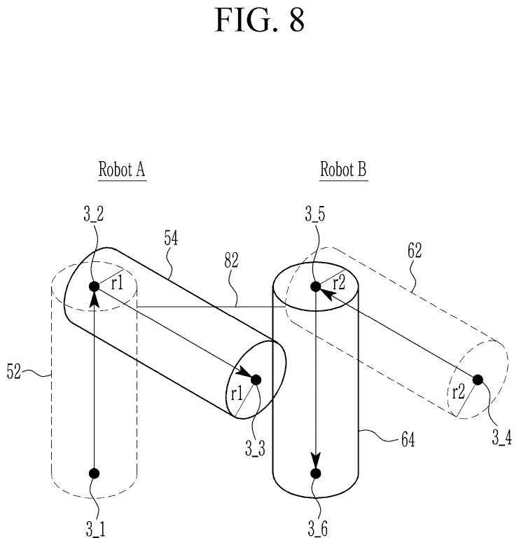

FIG. 8 is a drawing explaining the distance between robots according to one embodiment of the present disclosure.

Referring to FIG. 8, the distance between robots may be defined as the distance between the surfaces of cylinders representing the volume of the movement distance. The distance between the center axes of the cylinders does not reflect the actual size (volume) of the robot and/or the safety distance between robots. Therefore, in the embodiment, the distance between the surfaces of the cylinders may be used as the distance between the robots to prevent collisions between the robots and optimize the movement paths of the robots by reflecting the actual size (volume) of the robots and/or the safety distance between the robots.

For example, as illustrated in FIG. 8, in any one candidate movement direction combination, the movement direction of the task point movement path of the robot A has the task point 3_1 as the start point and the task point 3_3 as the end point, and the movement direction of the task point movement path of the robot B has the task point 3_4 as the start point and the task point 3_6 as the end point.

In the candidate movement direction combinations illustrated in FIG. 8, the movement direction determiner 26 may calculate the distance between robot A and robot B in the same time (step).

In some embodiments, the movement direction determiner 26 may calculate the distance between the volumes of the movement paths of robot A and robot B in the same time (step) and may use this as the distance between the robots.

First, the movement direction determiner 26 may calculate the distance 82 between the surfaces of cylinders 52 and 62 representing the volumes of the paths from the start point to the midpoint for the robot A and the robot B in the first step as the distance between the robots.

Next, the movement direction determiner 26 may calculate the distance between the surfaces of cylinders 54 and 64 representing the volumes of the paths from the midpoint to the end point for robot A and robot B in the second step as the distance between the robots. In FIG. 8, since some of the cylinders 54 and 64 overlap each other in the second step, the distance between the surfaces of the cylinders 54 and 64 can be calculated as 0 in the second step.

The movement direction determiner 26 may calculate the sum of the distance between robots calculated in the first step and the distance between robots calculated in the second step as the value of the second parameter in the candidate movement direction combination and may store the value of the second parameter in the candidate movement direction combination.

In FIG. 8, because only two robots are illustrated, the number of distance between robots calculated in the first step and the number of distance between robots calculated in the second step are each 1. However, if robots A, B, and C exist, the distances between the robots in the first step may be calculated as the distances between the robots A and B, between the robots A and C, and between the robots B and C, and the distances between robots in the second step may also be calculated as the distances between the robots A and B, between the robots A and C, and between the robots B and C, and the sum of these may be stored as the value of the second parameter in the candidate movement direction combination.

Again, referring to FIG. 4, the movement direction determiner 26 may determine one candidate movement direction combination from the plurality of plurality of candidate movement direction combinations using a movement direction selection cost function comprising a first cost function for the first parameter and a second cost function for the second parameter (S414).

In some embodiments, the movement direction selection function may be defined as in Equation 1.

$${Cost}_{T} = {Cost}_{A} + {Cost}_{D} \qquad ( Equation 1 )$$

Here, the Cost_{T} represents a cost function for selecting a movement direction, the Cost_{A} represents a first cost function for the first parameter, and the Cost_{D} represents a second cost function for the second parameter. The Cost_{A} and Cost_{D} may be expressed as Equations 2 and 3, respectively.

$${Cost}_{A} = f ( A ) \qquad ( Equation 2 )$$

In Equation 2, A may represent the sum of the overlapping volumes calculated in any one candidate movement direction combination. The f(A) is a cost function for A and the value of the f(A) may increase as A becomes smaller.

$${Cost}_{D} = f ( D ) \qquad ( Equation 3 )$$

In Equation 3, D may represent the sum of the distances between robots calculated in any one candidate movement direction combination. The f(D) is a cost function for D and the value of the f(D) may increase as D becomes larger.

In some embodiments, the movement direction determiner 26 may calculate the value of the movement direction selection cost function for each of the plurality of candidate movement direction combinations using the values of the first parameter and the second parameter calculated for each of the plurality of candidate movement direction combinations. The movement direction determiner 26 may select the candidate movement direction combination having the largest value among the values of the movement direction selection cost function calculated for each of the plurality of candidate movement direction combinations as an optimal movement direction combination.

In some embodiments, if there are two or more largest values among the movement direction selection cost functions calculated for each of a plurality of candidate movement direction combinations, the movement direction determiner 26 may select a candidate movement direction combination having the largest value of the first cost function among the candidate movement direction combinations having the two or more largest values. At this time, if there are two or more values of the largest first cost function, the candidate movement direction combination with the largest value of the second cost function may be selected.

The movement direction determiner 26 may control each robot to move according to the movement direction of each robot in the selected candidate movement direction combination (S416).

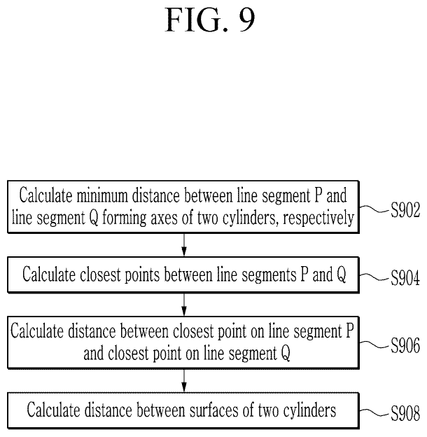

FIG. 9 is a drawing illustrating a method for calculating the surface-to-surface distance of cylinders used as a distance between robots according to one embodiment of the present disclosure.

Referring to FIG. 9, the movement direction determiner 26 may calculate the minimum distance between the line segment P generated when the robot A moves from one task point to another task point and the line segment Q generated when the robot B moves from one task point to another task point, at the same time (step) (S902).

In other words, when the volume of the movement distance that a robot moves from one task point to another task point in one step is represented by a cylinder, the movement direction determiner 26 may calculates the minimum distance between the line segment P forming the axis of a first cylinder representing the volume of the movement distance of the robot A and the line segment Q forming the axis of a second cylinder representing the volume of the movement distance of the robot B.

The movement direction determiner 26 may calculate the closest points between line segments P and Q (S904).

Vectors may be defined as in Equation 4 by line segments P and Q.

$$u = P 1 - P 0 , v = Q 1 - A 0 , w = P 0 - Q 0 \qquad ( Equation 4 )$$

In Equation 4, the P0 is the start point of line segment P, and the P1 is the end point of line segment P. The Q0 is the start point of line segment Q and the Q1 is the end point of line segment Q. The u represents the direction vector of line segment P, the v represents the direction vector of line segment Q, and the w represents the direction vector from the start point of line segment Q to the start point of line segment P.

At this time, the scalar value may be calculated as in Equation 5.

$$a = u \cdot u , b = u \cdot v , c = v \cdot v , d = u \cdot w , e = v \cdot w \qquad ( Equation 5 )$$

The movement direction determiner 26 may calculate parameters s and t to find the closest point between line segments P and Q. The parameters s and t may represent parameter values that represent a point on a line segment.

The denominator may be calculated as in Equation 6, and when line segments P and Q are not parallel, the parameters s and parameters t may be expressed as in Equation 7, and when line segments P and Q are parallel, the parameters s and parameters t may be expressed as in Equation 8.

$$denom = ac - b 2 \qquad ( Equation 6 )$$

$$s = \frac{b e - c d}{d e n o m} , t = \frac{a e - b d}{d e n o m} \qquad ( Equation 7 )$$

$$s = 0 , t = \frac{d}{b} ( however , b \neq 0 ) , otherwise t = 0 \qquad ( Equation 8 )$$

At this time, the values of parameter s and parameter t are restricted between 0 and 1 so that the closest points on line segment P and line segment Q may be considered only as points on line segment P and line segment Q, respectively.

The movement direction determiner 26 may calculate the closest point on line segment P and the closest point on line segment Q using parameters s and t. The closest point on line segment P and the closest point on line segment Q may be calculated as in Equation 9.

$${CP}_{P} = P 0 + su , {CP}_{Q} = P 0 + t v \qquad ( Equation 9 )$$

In Equation 9, CP_{P} represents the closest point on line segment P, and CP_{Q} represents the closest point on line segment Q.

Next, the movement direction determiner 26 may calculate the distance between the closest point on line segment P and the closest point on line segment Q (S906). The distance between the closest point on line segment P and the closest point on line segment Q may be calculated as in Equation 10, and the distance between the closest point on line segment P and the closest point on line segment Q becomes the minimum distance between line segments P and Q.

$$d = ‖ {CP}_{P} + {CP}_{Q} ‖ \qquad ( Equation 10 )$$

Here, ∥x∥ is the norm of vector x, which may represent the Euclidean distance or size, and using the norm, the distance between the closest point on line segment P and the closest point on line segment Q may be calculated, as in Equation 10.

Next, the movement direction determiner 26 may calculate the distance between the surfaces of the two cylinders by considering distance between the closest point on line segment P and the closest point on line segment Q and the radius of the first cylinder with line segment P as the axis, and the radius of the second cylinder with line segment Q as the axis (S908). The distance between the surfaces of two cylinders may be calculated as in Equation 11.

$${d}_{surface} = max ( 0 , d - ( r 1 - r 2 ) ) \qquad ( Equation 11 )$$

Here, the d represents the minimum distance between line segments P and Q, the r1 is the radius of the first cylinder with line segment P as its axis, and the r2 is the radius of the second cylinder with line segment Q as its axis.

According to Equation 11, when two cylinders overlap or contact, d−(r1 r2)≤0, so the distance between the surfaces of the two cylinders may be set to 0.

The distance between the surfaces of the two cylinders calculated from Equation 11 may be used as the distance between the robots when calculating the value of the second parameter.

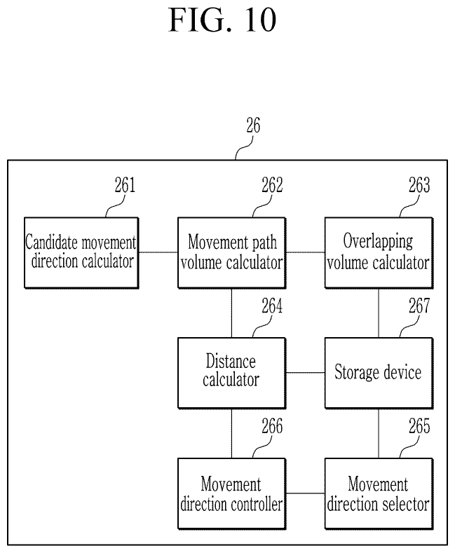

FIG. 10 is a drawing showing a movement direction determiner according to one embodiment of the present disclosure.

Referring to FIG. 10, the movement direction determiner 26 may include a candidate movement direction calculator 261, a movement path volume calculator 262, an overlapping volume calculator 263, a distance calculator 264, a movement direction selector 265, and a movement direction controller 266. The movement direction determiner 26 may further include a storage device 267.

The candidate movement direction calculator 261 may calculate a plurality of candidate movement direction combinations corresponding to the number of cases for the movement direction in which each of the plurality of robots may move on the task point movement path of each of the plurality of robots.

The movement path volume calculator 262 may calculate the volumes of the movement paths of each robot at each of a plurality of steps, for each of a plurality of candidate movement direction combinations.

The overlap volume calculator 263 may calculate the overlapping volume at each of the plurality of steps by using the volume of the movement path of each robot calculated at each of the plurality of steps, for each of the plurality of candidate movement direction combinations. The overlap volume calculator 263 may calculate the total overlapping volume of each candidate movement direction combination by adding up the overlapping volumes calculated at each of the plurality of steps, for each of the plurality of candidate movement direction combinations.

The overlap volume calculator 263 may store the sum of the overlapping volumes calculated for each of a plurality of candidate movement direction combinations in the storage device 267.

The distance calculator 264 may calculate the distance between robots at each of the plurality of steps using cylinders representing the volumes of the movement paths of each of the plurality of robots calculated at each of the plurality of steps, for each of the plurality of candidate movement direction combinations. The distance calculator 264 may calculate the total sum of the distances between robots for the corresponding candidate movement direction combination by adding up the distances between robots calculated at each of the plurality of steps.

The distance calculator 264 may store the sum of the distances between robots for each of a plurality of candidate movement direction combinations in the storage device 267.

The movement direction selector 265 may calculate the value of the movement direction selection cost function by using the sum of the overlapping volumes and the sum of the distances between robots, calculated for each of a plurality of candidate movement direction combinations. The movement direction selection cost function may include a first cost function for the sum of overlapping volumes corresponding to the first parameter and a second cost function for the sum of distances between robots corresponding to the second parameter, as in Equation 1.

The movement direction selector 265 may select the candidate movement direction combination having the largest value among the values of the movement direction selection cost function calculated for each of a plurality of candidate movement direction combinations as an optimal movement direction combination. If there are two or more largest values among the movement direction selection cost functions calculated for each of a plurality of candidate movement direction combinations, the movement direction selector 265 may select a candidate movement direction combination having a larger value of the first cost function among the candidate movement direction combinations having two or more largest values.

The movement direction controller 266 may control each robot to move according to the movement direction of each robot in the selected candidate movement direction combination.

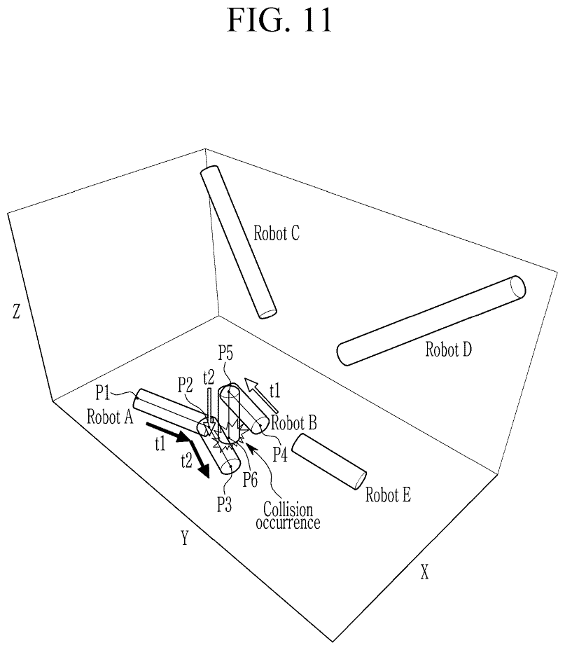

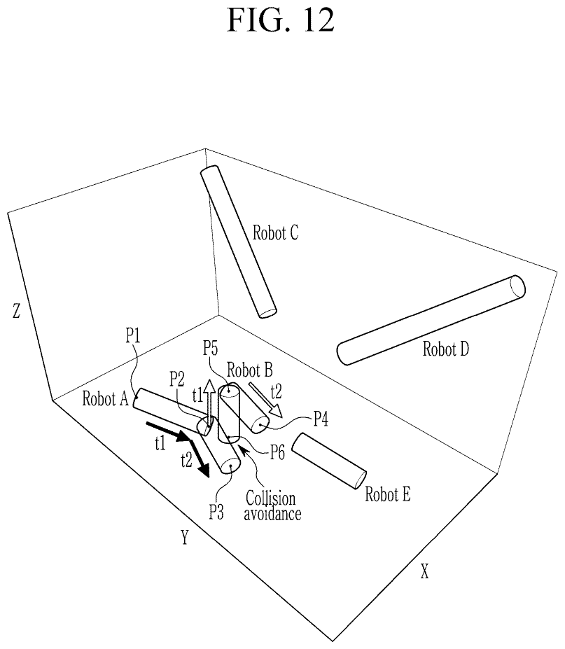

FIG. 11 is a drawing showing a collision area between robots when the movement direction in the task point movement path of each robot is not considered, and FIG. 12 is a drawing explaining collision avoidance between robots when the movement direction of each robot in the task point movement path is determined by a method for determining the movement direction of the robot according to an embodiment of the present disclosure.

In FIGS. 11 and 12, because robots C, D, and E have no possibility of collision with other robots, descriptions of robots C, D, and E are omitted.

Referring to FIG. 11, the robot A performs a task while moving in the direction from task point P1 to task point P2 to task point P3, and the robot B performs a task while moving in the direction from task point P4 to task point P5 to task point P6.

At time t1, the robot A moves from task point P1 to task point P2, and the robot B moves from task point P4 to task point P5. At this time, there is no overlap between the volume of the movement path of the robot A and the volume of the movement path of the robot B.

Meanwhile, at time t2, the robot A moves from task point P2 to task point P3, and the robot B moves from task point P5 to task point P6. At this time, there is an overlapping portion between the volume of the movement path of the robot A and the volume of the movement path of the robot B. In other words, a collision between the robots A and B may occur in the overlapping portion between the volume of the movement path of the robot A and the volume of the movement path of the robot B.

However, according to the method for determining the movement directions of robots according to an embodiment, the movement direction for the task point movement path of the robot A and the movement direction of the task point movement path of the robot B are determined such that the total sum of overlapping volumes between the volumes of the movement paths of the robot A and the volumes of the movement paths of the robot B is small, and the total sum of the distances between the surfaces of the cylinders representing the volumes of the movement paths of robot A and the surfaces of the cylinders representing the volumes of the movement path between robot B, i.e., the total sum of the distances between robots is large.

As a result, as shown in FIG. 12, the movement direction of the robot B may be determined in the direction from task point P6 to task point P5 to task point P4, unlike in FIG. 11.

Then, at time t1, the robot A moves from task point P1 to task point P2, and the robot B moves from task point P6 to task point P5. At this time, there is no overlap between the volume of the movement path of robot A and the volume of the movement path of the robot B.

In addition, at time t2, the robot A moves from task point P2 to task point P3, and the robot B moves from task point P5 to task point P4. At this time, there is no overlap between the volume of the movement path of the robot A and the volume of the movement path of the robot B.

In other words, by determining the movement direction of the robot B differently from that in FIG. 11, the collision between the robot A and the robot B at time t2 may be avoided.

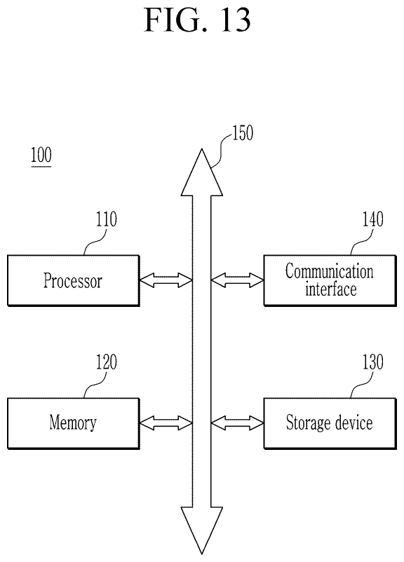

FIG. 13 is a drawing showing a multi-robot control apparatus according to another embodiment of the present disclosure.

Referring to FIG. 13, the multi-robot control apparatus 100 may represent a computing device in which the multi-robot control method and/or the robot movement direction determination method described above are implemented.

The multi-robot control apparatus 100 includes a processor 110, a memory 120, a storage device 130, a communication interface 140, and a bus 150. The multi-robot control apparatus 100 may further include other general-purpose components of a computing device.

The processor 110 may control the overall operation of each component of the multi-robot control apparatus 100. The processor 110 may be implemented as at least one of various processing units, such as a microprocessor, a central processing unit (CPU), a graphic processing unit (GPU), a microprocessor unit (MPU), or a micro controller unit (MCU). The processor 110 may also be implemented as a parallel processing unit. In addition, the processor 110 may perform operations for a program for executing the multi-robot control method and/or the robot movement direction determination method described above.

In some embodiments, the processor 110 may store a computer program for implementing at least some of the functions of the multi-robot control apparatus 20 illustrated in FIG. 2 and/or at least some of the functions of the movement direction determiner 26 illustrated in FIG. 10, in the memory 120.

The memory 120 may store various data, commands and/or information.

The memory 120 may load the computer program from the storage device 130 to execute the multi-robot control method and/or the robot movement direction determination method described above. The storage device 130 may store programs non-temporarily. The storage device 130 may be implemented as non-volatile memory.

The communication interface 140 may support wired and wireless Internet communication of the multi-robot control apparatus 100. In addition, the communication interface 140 may support various communication methods other than Internet communication.

The bus 150 may provide communication functions between components of the multi-robot control apparatus 100. The bus 150 may be implemented as various types of buses such as an address bus, a data bus, and a control bus.

The computer program may include instructions causing the processor 110 to perform a multi-robot control method and/or a robot movement direction determination method when loaded into the memory 120. In other words, the processor 110 may perform operations for a multi-robot control method and/or a robot movement direction determination method by executing instructions.

In some embodiments, the multi-robot control method and/or the robot movement direction determination method may be implemented as a computer program on a computer-readable storage medium. In some embodiments, the computer-readable recording medium may be a movable recording medium or a fixed recording medium. In some embodiments, a computer program recorded on a computer-readable recording medium may be transmitted to another computing device through a network such as the Internet and installed and executed on the other computing device.

According to at least one embodiment, by determining the movement direction of each of the plurality of robots in a way that minimizes collisions between the robots, by using the overlapping volumes between the robots and the distances between the robots, and by considering the volume of each robot in the task point movement path of each of the plurality of robots, collisions between the robots may be reduced, and thus interlocks between the robots may be reduced.

While the present disclosure has been described in connection with what is presently considered to be practical embodiments, it should be understood that the present disclosure is not limited to the disclosed embodiments. On the contrary, it is intended to cover various modifications and equivalent arrangements included within the spirit and scope of the appended claims.

What is claimed is:

1. A method for controlling a plurality of robots by executing commands stored in memory in a processor, the method comprising:
allocating task points among a plurality of task points to each of the plurality of robots;
determining a task point movement path for each of the plurality of robots to visit all of the allocated task points, for each of the plurality of robots;
calculating a plurality of candidate movement direction combinations based on the task point movement path of each of the plurality of robots;
calculating a sum of overlapping volumes between the plurality of robots and a sum of distances between the plurality of robots based on the task point movement path of each of the plurality of robots, for each of the plurality of candidate movement direction combinations;
determining a movement direction on the task point movement path of each of the plurality of robots by using the sum of the overlapping volumes between the plurality of robots and the sum of the distances between the plurality of robots calculated for each of the plurality of candidate movement direction combinations; and
controlling the plurality of robots to move according to the movement direction determined for each of the plurality of robots.

2. The method of claim 1, wherein determining the movement direction includes:
calculating a value of a movement direction selection cost function for each of the plurality of candidate movement direction combinations by using the sum of the overlapping volumes between the plurality of robots and the sum of the distances between the plurality of robots for each of the plurality of candidate movement direction combinations;
selecting a candidate movement direction combination by using the values of the movement direction selection cost function of the plurality of candidate movement direction combinations; and
determining a movement direction on task point movement path of each of the plurality of robots according to the selected candidate movement direction combination,
wherein the movement direction selection cost function includes a first cost function for the sum of the overlapping volumes and a second cost function for the sum of the distances between the plurality of robots.

3. The method of claim 2, wherein selecting includes:
selecting a candidate movement direction combination having a largest value among the values of the movement direction selection cost function of the plurality of candidate movement direction combinations, and
a value of the first cost function increases as the sum of the overlapping volumes decreases; and
a value of the second cost function increases as the sum of the distances between the plurality of robots increases.

4. The method of claim 3, wherein selecting the candidate movement direction combination having the largest value includes:
based on determining that there are two or more candidate movement direction combinations having largest values, selecting a candidate movement direction combination having a larger value of the first cost function among two or more candidate movement direction combinations having the largest values.

5. The method of claim 1, wherein calculating the sum of the overlapping volumes between the plurality of robots and the sum of distances between the plurality of robots includes:
calculating volumes of the task point movement paths between the plurality of task points in the task point movement path of each of the plurality of robots, for each of the plurality of candidate movement direction combinations;
calculating overlapping volumes between the task point movement paths of the plurality of robots for the same movement time between the plurality of task points by using the volumes of the task point movement paths between the plurality of task points calculated for each of the plurality of robots; and
calculating a total sum of the overlapping volumes between the plurality of robots by adding up the overlapping volumes calculated in the task point movement path of each of the plurality of robots, for each of the plurality of candidate movement direction combinations.

6. The method of claim 5, wherein calculating the volumes of the task point movement paths includes:
generating a cylinder having a radius reflecting a volume of the plurality of robot and a line segment representing the task point movement path as an axis in each of the movement paths between the plurality of task points of each of the plurality of robots; and
calculating a volume of the cylinder as the volume of the task point movement path.

7. The method of claim 5, wherein calculating the sum of overlapping volumes between the plurality of robots and the sum of distances between the plurality of robots further includes:
calculating the distances between robots at the same movement time between the plurality of task points by using the volumes of the task point movement paths between the plurality of task points calculated for each of the plurality of robots, for each of the plurality of candidate movement direction combinations; and
calculating the sum of the distances between the plurality of robots by adding up the distances between the plurality of robots calculated from the task point movement paths of each of the plurality of robots, for each of the plurality of candidate movement direction combinations.

8. The method of claim 7, wherein calculating the distances between the plurality of robots includes:
calculating a distance between surfaces of cylinders representing the volumes of the task point movement paths of the plurality of robots as the distance between the plurality of robots, at the same movement time between the plurality of task points.

9. The method of claim 8, wherein calculating the distance between the surfaces of the cylinders as the distance between the plurality of robots includes:
calculating a minimum distance between a first line segment forming an axis of a first cylinder and a second line segment forming an axis of a second cylinder at the same movement time between the plurality of task points; and
calculating a minimum distance between a surface of the first cylinder and a surface of the second cylinder as the distance between the plurality of robots, by considering the minimum distance between the first line segment and the second line segment and a radius of the first cylinder and a radius of the second cylinder.

10. A multi-robot control apparatus for controlling a plurality of robots, the multi-robot control apparatus comprising:
a memory configured to one or more commands; and
a processor, by executing the one or more commands, configured to:
allocate task points among a plurality of task points to each of the plurality of robots;
determine a task point movement path for each of the plurality of robots to visit all of the allocated task points, for each of the plurality of robots;
calculate a plurality of candidate movement direction combinations based on the task point movement path of each of the plurality of robots;
calculate a sum of overlapping volumes between the plurality of robots and a sum of distances between the plurality of robots based on the task point movement path of each of the plurality of robots, for each of the plurality of candidate movement direction combinations;
determine a movement direction on the task point movement path of each of the plurality of robots by using the sum of the overlapping volumes between the plurality of robots and the sum of the distances between the plurality of robots calculated for each of the plurality of candidate movement direction combinations; and
control the plurality of robots to move according to the movement direction on the task point movement path of each of the plurality of robots.

11. The multi-robot control apparatus of claim 10, wherein the processor is further configured to:
calculate the sum of the overlapping volumes between the plurality of robots based on the task point movement paths of each of the plurality of robots, for each of the plurality of candidate movement direction combinations;
calculate the sum of the distances between the plurality of robots based on the task point movement paths of each of the plurality of robots, for each of the plurality of candidate movement direction combinations;
select a candidate movement direction combination from among the plurality of candidate movement direction combinations by using the sum of the overlapping volumes and the sum of the distances between the plurality of robots of each of the plurality of candidate movement direction combinations; and
control the plurality of robots according to the movement directions of the plurality of robots to move according to the selected candidate movement direction combination.

12. The multi-robot control apparatus of claim 11, wherein the processor is further configured to:
calculate a value of a movement direction selection cost function, including a first cost function for the sum of the overlapping volumes and a second cost function for the sum of the distances between the plurality of robots, for each of the plurality of candidate movement direction combinations by using the sum of the overlapping volumes between the plurality of robots and the sum of the distances between the plurality of robots for each of the plurality of candidate movement direction combinations; and
select a candidate movement direction combination having a largest value among the values of the movement direction selection cost function of the plurality of candidate movement direction combinations,
wherein a value of the first cost function increases as the sum of the overlapping volumes is decreased, and a value of the second cost function increases as the sum of the distances between the plurality of robots is increased.

13. The multi-robot control apparatus of claim 12, wherein, when there are two or more candidate movement direction combinations having largest values among the values of the movement direction selection cost function of the plurality of candidate movement direction combinations, the processor is further configured to:
select a candidate movement direction combination having a larger value of the first cost function among the two or more candidate movement direction combinations having the largest values.

14. The multi-robot control apparatus of claim 11, wherein the processor is further configured to:
calculate volumes of the task point movement paths between the plurality of task points in the task point movement path of each of the plurality of robots, for each of the plurality of candidate movement direction combinations;
calculate overlapping volumes between the task point movement paths of the plurality of robots for the same movement time between the plurality of task points by using the volumes of the task point movement paths between the plurality of task points calculated for each of the plurality of robots; and
calculate a total sum of the overlapping volumes between the plurality of robots by adding up the overlapping volumes calculated in the task point movement path of each of the plurality of robots, for each of the plurality of candidate movement direction combinations.

15. The multi-robot control apparatus of claim 14, wherein the processor is further configured to:
generate a cylinder having a radius reflecting a volume of the robot and a line segment representing the task point movement path as an axis in each of the movement paths between the plurality of task points of each of the plurality of robots; and
calculate a volume of the cylinder as the volume of the task point movement path.

16. The multi-robot control apparatus of claim 15, wherein the processor is further configured to:
calculate the distances between the plurality of robots at the same movement time between the plurality of task points by using the volumes of the task point movement paths between the task points calculated for each of the plurality of robots, for each of the plurality of candidate movement direction combinations; and
calculate the sum of the distances between the plurality of robots by adding up the distances between the plurality of robots calculated from the task point movement paths of each of the plurality of robots, for each of the plurality of candidate movement direction combinations.

17. The multi-robot control apparatus of claim 16, wherein the processor is further configured to:
calculate a distance between surfaces of cylinders representing the volumes of the task point movement paths of the plurality of robots as the distance between the plurality of robots, at the same movement time between the plurality of task points.

18. The multi-robot control apparatus of claim 17, wherein the processor is further configured to:
calculate a minimum distance between a first line segment forming an axis of a first cylinder and a second line segment forming an axis of a second cylinder at the same movement time between the plurality of task points; and
calculate a minimum distance between a surface of the first cylinder and a surface of the second cylinder as the distance between the plurality of robots, by considering the minimum distance between the first line segment and the second line segment and a radius of the first cylinder and a radius of the second cylinder.
